(19) United States
(12) Patent Application Publication
(10) Pub. No.: US 2026/0205483 A1
(43) Pub. Date: Jul. 16, 2026

(54) System, Method, and Computer Program Product for Detecting Anomalies in Computing Systems Based on Correlated Session Data

(71) Applicant: VISA INTERNATIONAL SERVICE ASSOCIATION, San Francisco, CA (US)

(72) Inventors: Hanlin Chen, Danville, CA (US); Dominique Louis Fedronic, Belmont, CA (US); Jorge A. Corpus, San Carlos, CA (US)

(21) Appl. No.: 19/136,368

(22) PCT Filed: Dec. 8, 2023
(86) PCT No.: PCT/US23/83103

§ 371 Date: Jun. 6, 2025

Related U.S. Application Data
(60) Provisional application No. 63/431,400, filed on Dec. 9, 2022.

(51) Int. Cl. H04L 9/40; H04L 9/08

(52) U.S. Cl. CPC H04L 63/1425; H04L 9/0861

(57) ABSTRACT

Systems, methods, and computer program products are provided for detecting anomalies in computing systems using correlated session data from source servers and target servers. The method includes receiving a connection request for a connection to a target server from a source server, the connection request including a login request to a service account on the target server, the connection request initiated on the source server by a user account; generating a communication session for the user account between the source server and the target server based on the connection request; collecting target server session data associated with the target server and source server session data associated with the source server; correlating the target server session data with the source server session data to provide correlated session data; and detecting an anomaly based on the correlated session data.

### CROSS-REFERENCE TO RELATED APPLICATIONS

This application is the United States national phase of International Application No. PCT/US23/83103, filed Dec. 8, 2023, and claims priority to U.S. Provisional Patent Application No. 63/431,400 , filed Dec. 9, 2022, the disclosures of which are hereby incorporated by reference in their entireties.

### BACKGROUND

### 1. Technical Field

This disclosure relates generally to detecting anomalies in computing systems and, in some non-limiting embodiments or aspects, to systems, methods, and computer program products for detecting anomalies in computing systems based on correlated session data.

### 2. Technical Considerations

In some instances, a computing system (e.g., a system of one or more computing devices connected via a communication network) may be configured such that the computing system is protected by a subsystem implemented with hardware and/or software at a perimeter level of the computing system (e.g., a firewall and/or the like). However, the computing system may not have micro-segmentation implemented in the computing system. Micro-segmentation may include subsystems implemented with software instructions that protect (e.g., monitor, block, blacklist, and/or the like) connections and/or communications from one computing device to another computing device via the communication network within the computing system.

However, micro-segmentation may be difficult and/or costly to implement in a computing system. Computing systems without micro-segmentation may be vulnerable to lateral attacks (e.g., computing device-to-computing device connections and/or communications via the communication network within the computing system that may be unauthorized, harmful, malicious, and/or the like). Lateral attacks may be initiated in a computing system via a first computing device and may result in a user gaining access to a second computing device in the computing system via the first computing device. For example, the first computing device may be considered to be a low risk computing device (e.g., based on the computing device storing and/or accessing public information) and/or a computing device to which the user is authorized to access. The second computing device may be considered to be a high risk computing device (e.g., based on the computing device storing and/or accessing sensitive and/or private information) and/or a computing device to which the user is unauthorized to access. The user may thus gain access to the second computing device via a lateral attack that was initiated on the first computing device, and that access may be difficult to detect, difficult to trace, and/or difficult to prevent.

### SUMMARY

Accordingly, provided are improved systems, methods, and computer program products for detecting anomalies in computing systems.

According to some non-limiting embodiments or aspects, provided is a computer-implemented method for detecting anomalies in computing systems (e.g., server systems) including receiving a connection request for a connection to a target server from a source server. The connection request may include a login request to a service account on the target server. The connection request may be initiated on the source server by a user account. The method may further include generating a communication session for the service account between the source server and the target server based on the connection request. The method may further include collecting target server session data associated with the target server and including a service account identifier of the service account. The method may further include collecting source server session data associated with the source server and including a user account identifier of the user account based on the communication session. The method may further include correlating the target server session data with the source server session data to provide correlated session data. The method may further include detecting an anomaly based on the correlated session data.

In some non-limiting embodiments or aspects, the method may further include generating an alert based on detecting the anomaly. The method may further include terminating the communication session for the service account based on the alert.

In some non-limiting embodiments or aspects, the method may further include storing the target server session data and the source server session data in a data repository.

In some non-limiting embodiments or aspects, the method may further include retrieving the target server session data and the source server session data from a data repository.

In some non-limiting embodiments or aspects, correlating the target server session data with the source server session data to provide correlated session data may include correlating a first copy of a target server identifier of the target server session data with a second copy of the target server identifier of the source session data. Correlating the target server session data with the source server session data to provide correlated session data may further include correlating a first copy of a source server identifier of the target server session data with a second copy of the source server identifier of the source session data. Correlating the target server session data with the source server session data to provide correlated session data may further include correlating a first copy of a target port number of the target server session data with a second copy of the target port number of the source server session data. Correlating the target server session data with the source server session data to provide correlated session data may further include correlating a first copy of a source port number of the target server session data with a second copy of the source port number of the source server session data. Correlating the target server session data with the source server session data to provide correlated session data may further include correlating a target time stamp of the target server session data with a source time stamp of the source server session data. The target time stamp may include a time stamp associated with a time the communication session is generated. The source time stamp may include a time stamp associated with a time the source server receives a response from the target server that the communication session is generated.

In some non-limiting embodiments or aspects, detecting the anomaly based on the correlated session data may include identifying the user account that initiated the communication session and the service account associated with the communication session based on the correlated session data. The correlated session data may include the user account identifier of the source server session data and the service account identifier of the target server session data. Detecting the anomaly based on the correlated session data may further include determining that the anomaly is present. Determining that the anomaly is present may include comparing activity of the user account with one or more anomaly criteria. Detecting the anomaly based on the correlated session data may further include determining that the activity of the user account satisfies the one or more anomaly criteria.

According to some non-limiting embodiments or aspects, provided is a system including at least one processor and at least one non-transitory computer-readable medium storing instructions that, when executed by the at least one processor, cause the at least one processor to receive a connection request for a connection to a target server from a source server. The connection request may include a login request to a service account on the target server. The connection request may be initiated on the source server by a user account. A communication session for the service account between the source server and the target server may be generated based on the connection request. Target server session data associated with the target server and comprising a service account identifier of the service account and source server session data associated with the source server and comprising a user account identifier of the user account may be collected based on the communication session. The target server session data may be correlated with the source server session data to provide correlated session data. An anomaly may be detected based on the correlated session data.

In some non-limiting embodiments or aspects, an alert may be generated based on detecting the anomaly. The communication session for the user account may be terminated based on the alert.

In some non-limiting embodiments or aspects, the communication session may be based on a secure shell protocol.

In some non-limiting embodiments or aspects, the target server session data and the source server session data may be stored in a data repository.

In some non-limiting embodiments or aspects, the login request may include a username of the service account and a password of the service account.

In some non-limiting embodiments or aspects, the login request may include a key associated with a secure shell protocol.

In some non-limiting embodiments or aspects, correlating the target server session data with the source server session data to provide correlated session data may include correlating a first copy of a target server identifier of the target server session data with a second copy of the target server identifier of the source session data, correlating a first copy of a source server identifier of the target server session data with a second copy of the source server identifier of the source session data, correlating a first copy of a target port number of the target server session data with a second copy of the target port number of the source server session data, correlating a first copy of a source port number of the target server session data with a second copy of the source port number of the source server session data, and correlating a target time stamp of the target server session data with a source time stamp of the source server session data. The target time stamp may be associated with a time the communication session is generated. The source time stamp may be associated with a time the source server receives a response from the target server that the communication session is generated.

In some non-limiting embodiments or aspects, detecting the anomaly based on the correlated session data may include identifying the user account that initiated the communication session and the service account associated with the communication session based on the correlated session data, the correlated session data comprising the user account identifier of the source server session data and the service account identifier of the target server session data; and determining that the anomaly is present. Determining that the anomaly is present may include comparing activity of the user account with one or more anomaly criteria and determining that the activity of the user account satisfies the one or more anomaly criteria.

According to some non-limiting embodiments or aspects, provided is a computer program product including at least one non-transitory computer-readable medium including program instructions that, when executed by at least one processor, cause the at least one processor to receive a connection request for a connection to a target server from a source server. The connection request may include a login request to a service account on the target server. The connection request may be initiated on the source server by a user account. A communication session for the service account between the source server and the target server may be generated based on the connection request. Target server session data associated with the target server and comprising a service account identifier of the service account and source server session data associated with the source server and comprising a user account identifier of the user account may be collected based on the communication session. The target server session data may be correlated with the source server session data to provide correlated session data. An anomaly may be detected based on the correlated session data.

According to some non-limiting embodiments or aspects, provided is a system including at least one processor and at least one non-transitory computer-readable medium storing instructions that, when executed by the at least one processor, cause the at least one processor to perform any of the methods described herein.

According to some non-limiting embodiments or aspects, provided is a computer program product including at least one non-transitory computer-readable medium including program instructions that, when executed by at least one processor, cause the at least one processor to perform any of the methods described herein.

Other non-limiting embodiments or aspects will be set forth in the following numbered clauses:
Clause 1: A computer-implemented method, comprising: receiving, with at least one processor, a connection request for a connection to a target server from a source server, the connection request comprising a login request to a service account on the target server, wherein the connection request is initiated on the source server by a user account; generating, with at least one processor, a communication session for the service account between the source server and the target server based on the connection request; collecting, with at least one processor, target server session data associated with the target server and comprising a service account identifier of the service account and source server session data associated with the source server and comprising a user account identifier of the user account based on the communication session; correlating, with at least one processor, the target server session data with the source server session data to provide correlated session data; and detecting, with at least one processor, an anomaly based on the correlated session data.
Clause 2: The computer-implemented method of clause 1, further comprising: generating, with at least one processor, an alert based on detecting the anomaly; and terminating, with at least one processor, the communication session for the service account based on the alert.
Clause 3: The computer-implemented method of clause 1 or clause 2, wherein the communication session is based on a secure shell protocol.
Clause 4: The computer-implemented method of any of clauses 1-3, further comprising: storing, with at least one processor, the target server session data and the source server session data in a data repository.
Clause 5: The computer-implemented method of any of clauses 1-4, wherein the login request comprises a username of the service account and a password of the service account.
Clause 6: The computer-implemented method of any of clauses 1-5, wherein the login request comprises a key associated with a secure shell protocol.
Clause 7: The computer-implemented method of any of clauses 1-6, wherein the target server session data further comprises: a source server identifier associated with the source server; a target server identifier associated with the target server; a source port number associated with the source server; a target port number associated with the target server; a target time stamp associated with a time the communication session is generated; or any combination thereof.
Clause 8: The computer-implemented method of any of clauses 1-7, wherein the source server session data further comprises: the source server identifier associated with the source server; the target server identifier associated with the target server; the source port number associated with the source server; the target port number associated with the target server; a source time stamp associated with a time the source server receives a response from the target server that the communication session is generated; or any combination thereof.
Clause 9: The computer-implemented method of any of clauses 1-8, further comprising: retrieving, with at least one processor, the target server session data and the source server session data from the data repository.
Clause 10: The computer-implemented method of any of clauses 1-9, wherein correlating the target server session data with the source server session data to provide correlated session data comprises: correlating a first copy of a target server identifier of the target server session data with a second copy of the target server identifier of the source session data; correlating a first copy of a source server identifier of the target server session data with a second copy of the source server identifier of the source session data; correlating a first copy of a target port number of the target server session data with a second copy of the target port number of the source server session data; correlating a first copy of a source port number of the target server session data with a second copy of the source port number of the source server session data; and correlating a target time stamp of the target server session data with a source time stamp of the source server session data, the target time stamp associated with a time the communication session is generated, the source time stamp associated with a time the source server receives a response from the target server that the communication session is generated.
Clause 11: The computer-implemented method of any of clauses 1-10, wherein detecting the anomaly based on the correlated session data comprises: identifying the user account that initiated the communication session and the service account associated with the communication session based on the correlated session data, the correlated session data comprising the user account identifier of the source server session data and the service account identifier of the target server session data; and determining that the anomaly is present, wherein determining that the anomaly is present comprises: comparing activity of the user account with one or more anomaly criteria; and determining that the activity of the user account satisfies the one or more anomaly criteria.
Clause 12: A system comprising: at least one processor; and at least one non-transitory computer-readable medium storing instructions that, when executed by the at least one processor, cause the at least one processor to: receive a connection request for a connection to a target server from a source server, the connection request comprising a login request to a service account on the target server, wherein the connection request is initiated on the source server by a user account; generate a communication session for the service account between the source server and the target server based on the connection request; collect target server session data associated with the target server and comprising a service account identifier of the service account and source server session data associated with the source server and comprising a user account identifier of the user account based on the communication session; correlate the target server session data with the source server session data to provide correlated session data; and detect an anomaly based on the correlated session data.
Clause 13: The system of clause 12, wherein the instructions, when executed by the at least one processor, further cause the at least one processor to: generate an alert based on detecting the anomaly; and terminate the communication session for the user account based on the alert.
Clause 14: The system of clause 12 or clause 13, wherein the communication session is based on a secure shell protocol.
Clause 15: The system of any of clauses 12-14, wherein the instructions, when executed by the at least one processor, further cause the at least one processor to: store the target server session data and the source server session data in a data repository.
Clause 16: The system of any of clauses 12-15, wherein the login request comprises a username of the service account and a password of the service account.
Clause 17: The system of any of clauses 12-16, wherein the login request comprises a key associated with a secure shell protocol.
Clause 18: The system of any of clauses 12-17, wherein correlating the target server session data with the source server session data to provide correlated session data comprises: correlating a first copy of a target server identifier of the target server session data with a second copy of the target server identifier of the source session data; correlating a first copy of a source server identifier of the target server session data with a second copy of the source server identifier of the source session data; correlating a first copy of a target port number of the target server session data with a second copy of the target port number of the source server session data; correlating a first copy of a source port number of the target server session data with a second copy of the source port number of the source server session data; and correlating a target time stamp of the target server session data with a source time stamp of the source server session data, the target time stamp associated with a time the communication session is generated, the source time stamp associated with a time the source server receives a response from the target server that the communication session is generated.
Clause 19: The system of any of clauses 12-18, wherein detecting the anomaly based on the correlated session data comprises: identifying the user account that initiated the communication session and the service account associated with the communication session based on the correlated session data, the correlated session data comprising the user account identifier of the source server session data and the service account identifier of the target server session data; and determining that the anomaly is present, wherein determining that the anomaly is present comprises: comparing activity of the user account with one or more anomaly criteria; and determining that the activity of the user account satisfies the one or more anomaly criteria.
Clause 20: A computer program product comprising at least one non-transitory computer-readable medium including program instructions that, when executed by at least one processor, cause the at least one processor to: receive a connection request for a connection to a target server from a source server, the connection request comprising a login request to a service account on the target server, wherein the connection request is initiated on the source server by a user account; generate a communication session for the service account between the source server and the target server based on the connection request; collect target server session data associated with the target server and comprising a service account identifier of the service account and source server session data associated with the source server and comprising a user account identifier of the user account based on the communication session; correlate the target server session data with the source server session data to provide correlated session data; and detect an anomaly based on the correlated session data.
Clause 21: A system comprising: at least one processor; and at least one non-transitory computer-readable medium storing instructions that, when executed by the at least one processor, cause the at least one processor to perform the method of any preceding claim.
Clause 22: A computer program product comprising at least one non-transitory computer-readable medium including program instructions that, when executed by at least one processor, cause the at least one processor to perform the method of any one of clauses 1-11.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for detecting anomalies in computing systems based on correlated session data, according to some non-limiting embodiments or aspects;

FIG. 2 is a flow diagram for a method of detecting anomalies in computing systems based on correlated session data, according to some non-limiting embodiments or aspects;

FIG. 3 is a diagram of an exemplary environment in which methods, systems, and/or computer program products, described herein, may be implemented, according to some non-limiting embodiments or aspects;

FIG. 4 is a schematic diagram of example components of one or more devices of FIG. 1 and/or FIG. 3, according to some non-limiting embodiments or aspects; and

FIG. 5 is a schematic diagram of an exemplary implementation of a system and method for detecting anomalies in computing systems based on correlated session data, according to some non-limiting embodiments or aspects.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for detecting anomalies including, but not limited to, detecting anomalies in computing systems based on correlated session data from source servers and/or target servers. For example, non-limiting embodiments or aspects of the disclosed subject matter provide receiving a connection request for a connection to a target server from a source server. The connection request may include a login request to a service account on the target server. The connection request may be initiated on the source server by a user account. Non-limiting embodiments or aspects may generate a communication session for the service account between the source server and the target server based on the connection request. Non-limiting embodiments or aspects may collect target server session data associated with the target server and source server session data associated with the source server. The target server session data may include a service account identifier of the service account based on the communication session. The source server session data may include a user account identifier of the user account based on the communication session. Non-limiting embodiments or aspects may correlate the target server session data with the source server session data to provide correlated session data. Non-limiting embodiments or aspects may detect an anomaly (e.g., in the computing system, with regard to a user account, etc.) based on the correlated session data. Such embodiments or aspects may provide techniques and systems that protect a computing system (e.g., a system of one or more computing devices, such as servers, connected via a communication network) from lateral attacks (e.g., computing device-to-computing device connections and/or communications via the communication network within the computing system that may be unauthorized, harmful, malicious, and/or the like) and/or prevent lateral attacks where the computing system does not implement micro-segmentation. Non-limiting embodiments or aspects may detect lateral attacks that may be initiated in a computing system via a computing device that may be considered to be a low risk computing device (e.g., the computing device stores public information and/or is accessible by a plurality of users). Non-limiting embodiments or aspects may detect lateral attacks where a user attempts to gain access to a computing device in the computing system that may be considered to be a high risk computing device (e.g., the computing device stores sensitive and/or private information). Non-limiting embodiments or aspects may detect lateral attacks based on a username of the user attempting to gain access to the computing device considered to be the high risk computing device. Non-limiting embodiments or aspects provide for the collection and/or extraction of information associated with the user (e.g., the username of the user, network information, source information, and/or the like) and information associated with the computing device the user is attempting to access (e.g., destination information, destination port, destination hostname, and/or the like). Non-limiting embodiments or aspects may leverage the information associated with the user account and the information associated with the computing device that the user account is attempting to access (e.g., the target computing device) in order to detect activity of the user account (e.g., a user using the user account) that may be malicious (e.g., anomalies, anomalous activity of a user, and/or the like).

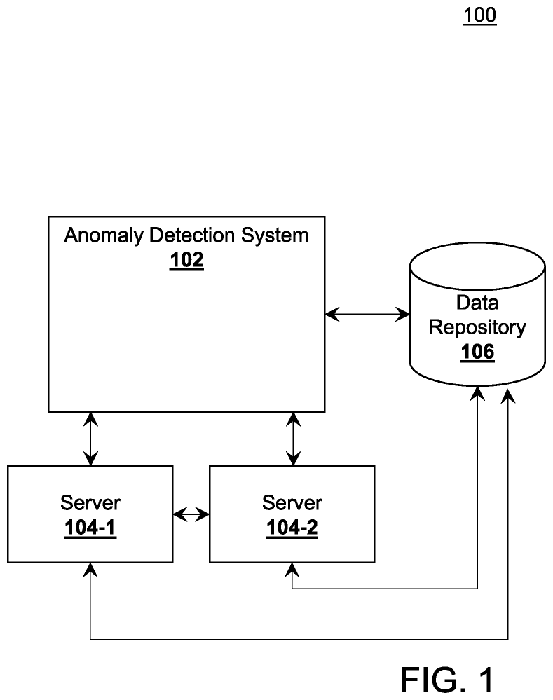

FIG. 1 depicts a system 100 for detecting anomalies in computing systems based on correlated session data, according to some non-limiting embodiments or aspects. The system 100 may include anomaly detection system 102, a plurality of servers (e.g., first server 104-1 and second server 104-2, collectively referred to as “servers 104” and individually referred to as “server 104”), and/or data repository 106. Anomaly detection system 102, servers 104, and/or data repository 106 may interconnect (e.g., establish a connection to communicate) via wired connections, wireless connections, or a combination of wired and wireless connections.

Anomaly detection system 102 may include a computing device, such as a server (e.g., a single server), a group of servers, and/or other like devices. In some non-limiting embodiments or aspects, anomaly detection system 102 may include a processor and/or memory, as described herein. In some non-limiting embodiments or aspects, anomaly detection system 102 may include one or more software instructions (e.g., one or more software applications) executing on a server (e.g., a single server), a group of servers, a computing device (e.g., a single computing device), a group of computing devices, and/or other like devices. In some non-limiting embodiments or aspects, anomaly detection system 102 may be configured to perform one or more steps of methods described herein. In some non-limiting embodiments or aspects, anomaly detection system 102 may be configured to communicate with servers 104 and/or data repository 106. In some non-limiting embodiments or aspects, anomaly detection system 102 may be in communication with servers 104 and/or data repository 106 such that anomaly detection system 102 is separate from servers 104 and/or data repository 106. In some non-limiting embodiments or aspects, at least one server 104 (e.g., all servers 104) and/or data repository 106 may be implemented by (e.g., may be part of) anomaly detection system 102.

Each server 104 may include at least one server, computing device, and/or at least one processor (e.g., a multi-core processor), such as a central processing unit (CPU), an accelerated processing unit (APU), a graphics processing unit (GPU), a microprocessor, and/or the like. In some non-limiting embodiments or aspects, server 104 may be configured to perform one or more steps of methods described herein. In some non-limiting embodiments or aspects, server 104 may be in communication with data repository 106. In some non-limiting embodiments or aspects, server 104 may be configured to receive information from and/or communicate (e.g., transmit) information to anomaly detection system 102, data repository 106, and/or one or more other servers 104. In some non-limiting embodiments or aspects, server 104 may execute a software instance (e.g., an instance of a software application including software instructions) of anomaly detection system 102. In some non-limiting embodiments or aspects, server 104 may be implemented by (e.g., may be part of) anomaly detection system 102. Alternatively, server 104 may be in communication with anomaly detection system 102 such that server 104 is separate from anomaly detection system 102.

In some non-limiting embodiments or aspects, at least one server 104 may include a bastion host. A bastion host may refer to a special-purpose computer (e.g., a special-purpose server) in a communication network that may be configured to withstand attacks. For example, a bastion host may execute (e.g., host) one process and/or application (e.g., a proxy server, load balancer, and/or the like). In some non-limiting embodiments or aspects, a bastion host may not store sensitive or private information and/or may act as a gateway to a communication network (e.g., a server through which all traffic must pass through in order to be transmitted within the communication network). In some non-limiting embodiments or aspects, a bastion host may include a first target server for which one or more client devices may connect to by transmitting a connection request from a user account on the one or more client devices to the bastion host. In this way, a client device may include a first source server.

Data repository 106 may include a computing device (e.g., a database device and/or the like) configured to communicate with anomaly detection system 102 and/or servers 104 via a communication network. For example, data repository 106 may include a server, a group of servers, and/or other like devices. In some non-limiting embodiments or aspects, data repository 106 may be associated with one or more computing devices providing interfaces such that a user (e.g., an administrative user, a user using a service account, and/or the like) may interact with data repository 106 via the one or more computing devices. Data repository 106 may be in communication with anomaly detection system 102 and/or servers 104 such that data repository 106 is separate from anomaly detection system 102 and/or servers 104. Alternatively, in some non-limiting embodiments or aspects, data repository 106 may be implemented by (e.g., may be part of) anomaly detection system 102 and/or at least one server 104.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple distributed systems or devices. Additionally or alternatively, a set of systems (e.g., one or more systems) or a set of devices (e.g., one or more devices) of system 100 may perform one or more functions described as being performed by another set of systems or another set of devices of system 100.

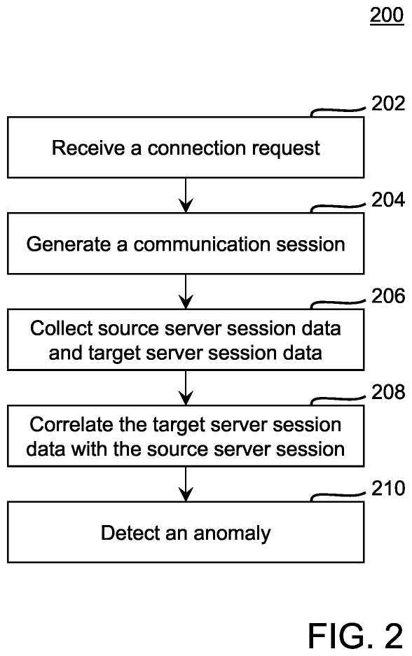

Referring now to FIG. 2, shown is a process 200 for detecting anomalies in computing systems using correlated session data, according to some non-limiting embodiments or aspects. The steps shown in FIG. 2 are for example purposes only. It will be appreciated that additional, fewer, different, and/or a different order of steps may be used in non-limiting embodiments or aspects.

As shown in FIG. 2, at step 202, process 200 may include receiving a connection request. For example, second server 104-2 may receive a connection request for a connection to second server 104-2 (e.g., a target server) from first server 104-1 (e.g., a source server). In some non-limiting embodiments or aspects, the connection request may include a login request (e.g., a request including login credentials) to a service account on second server 104-2 (e.g., the target server). In some non-limiting embodiments or aspects, the login request may include a username of the service account and a password of the service account (e.g., login credentials). In some non-Attorney limiting embodiments or aspects, the login request may include a key associated with a secure protocol (e.g., the Secure Shell (SSH) protocol).

In some non-limiting embodiments or aspects, the connection request may be initiated on first server 104-1 (e.g., the source server) by a user account (e.g., a user logged into and/or using the user account). In some non-limiting embodiments or aspects, a service account may include an account (e.g., an account for gaining access to a computing system) that may include one or more access levels (e.g., roles, such as a privileged user role, an administrative user role, a root role, and/or the like). A service account may refer to an account that may be accessible to an application (e.g., service) running on the server.

In some non-limiting embodiments or aspects, a source server (e.g., for one connection request and/or communication session) may include a target server (e.g., of another connection request and/or communication session). For example, a first server may include a first source server, and a second server may include a first target server. The second server may include a second source server, and a third server may include a second target server. In such an example, the third server may include a target server in relation to the second server, and the second server may include a source server in relation to the third server. Thus, the second server may include the first target server and a second source server (e.g., a chain of communication sessions from the first server to the second server to the third server). In this way, the second server may include a target server in relation to the first server, and the second server may include a source server in relation to the third server. Thus, anomaly detection system 102 may include and/or be in communication with a plurality of servers 104, where each server 104 may include a source server and/or a target server (e.g., for different communication sessions).

As shown in FIG. 2, at step 204, process 200 may include generating a communication session. For example, second server 104-2 (e.g., the target server) may generate a communication session for the service account based on the connection request. In some non-limiting embodiments or aspects, the communication session may include a communication session between first server 104-1 (e.g., the source server) and second server 104-2 (e.g., the target server). A communication session may refer to a two-way link (e.g., a connection, a channel, and/or the like) between a first computing device and a second computing device. The two-way link may facilitate the exchange of information (e.g., data, messages, requests, responses, and/or the like) between the first computing device and the second computing device. A communication session may be generated at a first point in time and the communication session may be terminated at a second point in time later than the first point in time. The first computing device and the second computing device communicating via the communication session may include data associated with a state of the communication session (e.g., data associated with login credentials, data associated with time stamps, data associated with a source server and/or a target server, and/or the like). A communication session may not be accessible by other computing devices and may only be accessible by the first computing device and the second computing device where the first computing device and the second computing device established the communication session initially.

In some non-limiting embodiments or aspects, the communication session may include a session based on a Hypertext Transfer Protocol (HTTP), a session based on telnet, and/or another type of communication session that may implement and/or may be based on an application layer protocol. In some non-limiting embodiments or aspects, the communication session may be based on a secure protocol (e.g., the Secure Shell (SSH) protocol).

As shown in FIG. 2, at step 206, process 200 may include collecting source server session data and target server session data. For example, second server 104-2 (e.g., the target server) and/or an instance (e.g., agent) of anomaly detection system 102 running on second server 104-2 may collect target server session data associated with the target server (e.g., based on the communication session). Additionally or alternatively, first server 104-1 (e.g., the source server) and/or an instance (e.g., agent) of anomaly detection system 102 running on first server 104-1 may collect source server session data associated with the source server (e.g., based on the communication session). In some non-limiting embodiments or aspects, the target server session data may include a service account identifier (e.g., a username) of the service account. In some non-limiting embodiments or aspects, the source server session data may include a user account identifier (e.g., a username) of the user account. In some non-limiting embodiments or aspects, anomaly detection system 102 (and/or each server 104) may store the target server session data and/or the source server session data in data repository 106. In some non-limiting embodiments or aspects, anomaly detection system 102 may receive (e.g., retrieve, access, and/or the like) the target server session data and/or the source server session data from the data repository (e.g., data repository 106).

In some non-limiting embodiments or aspects, target server session data may refer to data associated with the target server (e.g., second server 104-2) that is tracked (e.g., stored and/or saved) by the target server participating in the communication session and/or used by the target server participating in the communication session to facilitate the communication session (e.g., data associated with a state of the communication session). For example, target server session data may refer to data associated with the target server that identifies the target server as one or more endpoints of the communication session (e.g., a hostname, a port number, a process identifier, an Internet Protocol (IP) address, and/or the like), where the one or more endpoints may transmit and/or receive messages (e.g., requests and/or responses). Target server session data may refer to data associated with the target server that is generated based on the communication session. For example, target server session data may refer to data associated with one or more time stamps generated by the communication session, data associated with one or more messages transmitted via the communication session, and/or the like.

In some non-limiting embodiments or aspects, source server session data may refer to data associated with the source server (e.g., first server 104-1) that is tracked by the source server participating in the communication session and/or used by the source server participating in the communication session to facilitate the communication session. For example, source server session data may refer to data associated with the source server that identifies the source server as one or more endpoints of the communication session (e.g., a hostname, a port number, a process identifier, an IP address, and/or the like), where the one or more endpoints may transmit and/or receive messages. Source server session data may refer to data associated with the source server that is generated based on the communication session. For example, source server session data may refer to data associated with one or more time stamps generated by the communication session, data associated with one or more messages transmitted via the communication session, and/or the like.

In some non-limiting embodiments or aspects, when there are multiple communication sessions between different servers 104 (e.g., a chain of communication sessions), a particular server 104 acting as a target server for one communication session and a source server for another communication session may collect (e.g., via an instance of anomaly detection system 102 thereon) both source server session data for the one communication session and target server session data for the other communication session. In this way, the particular server 104 may collect target session data based on a first communication session in which the particular server 104 includes a target server and/or source server session data based on a second communication session in which the particular server 104 includes a source server.

In some non-limiting embodiments or aspects, the target server session data may include a source server identifier associated with the source server (e.g., an IP address, a hostname, and/or the like). In some non-limiting embodiments or aspects, the target server session data may include a target server identifier associated with the target server (e.g., an IP address, a hostname, and/or the like). In some non-limiting embodiments or aspects, the target server session data may include a source port number associated with the source server and/or a target port number associated with the target server. In some non-limiting embodiments or aspects, the target server session data may include a target time stamp associated with a time the communication session is generated (e.g., a time stamp indicating the time the communication session was generated by the target server).

In some non-limiting embodiments or aspects, the source server session data may include a source server identifier associated with the source server. In some non-limiting embodiments or aspects, the source server session data may include a target server identifier associated with the target server. In some non-limiting embodiments or aspects, the source server session data may include a source port number associated with the source server and/or a target port number associated with the target server. In some non-limiting embodiments or aspects, the source server session data may include a source time stamp associated with a time the source server receives a response from the target server that the communication session is generated (e.g., a time stamp indicating the time the source server received confirmation that the communication session was generated by the target server).

As shown in FIG. 2, at step 208, process 200 may include correlating the target server session data with the source server session data. For example, anomaly detection system 102 may correlate the target server session data with the source server session data to provide correlated session data. In some non-limiting embodiments or aspects, anomaly detection system 102 may correlate the target server session data with the source server session data based on comparing the target server session data with the source server session data from the communication session.

In some non-limiting embodiments or aspects, anomaly detection system 102 may correlate the target server session data with the source server session data to provide correlated session data by correlating a first copy of a target server identifier of the target server session data with a second copy of the target server identifier of the source session data. In some non-limiting embodiments or aspects, anomaly detection system 102 may correlate the target server session data with the source server session data to provide correlated session data by correlating a first copy of a source server identifier of the target server session data with a second copy of the source server identifier of the source session data.

In some non-limiting embodiments or aspects, anomaly detection system 102 may correlate the target server session data with the source server session data to provide correlated session data by correlating a first copy of a target port number of the target server session data with a second copy of the target port number of the source server session data. In some non-limiting embodiments or aspects, anomaly detection system 102 may correlate the target server session data with the source server session data to provide correlated session data by correlating a first copy of a source port number of the target server session data with a second copy of the source port number of the source server session data.

In some non-limiting embodiments or aspects, anomaly detection system 102 may correlate the target server session data with the source server session data to provide correlated session data by correlating a target time stamp of the target server session data with a source time stamp of the source server session data. In some non-limiting embodiments or aspects, the target time stamp may include a time stamp associated with a time the communication session is generated. In some non-limiting embodiments or aspects, the source time stamp may include a time stamp associated with a time the source server receives a response from the target server that the communication session is generated (e.g., a confirmation response, a response confirming the communication session has been generated, and/or the like).

As shown in FIG. 2, at step 210, process 200 may include detecting an anomaly. For example, anomaly detection system 102 may detect an anomaly (e.g., an anomaly with regard to activity of a user account and/or a service account on the target server) based on the correlated session data. In some non-limiting embodiments or aspects, anomaly detection system 102 may detect the anomaly based on the correlated session data by identifying the user account that initiated the communication session and/or identifying the service account associated with the communication session based on the correlated session data. In some non-limiting embodiments or aspects, the correlated session data may include the user account identifier of the source server session data and the service account identifier of the target server session data.

In some non-limiting embodiments or aspects, anomaly detection system 102 may detect the anomaly based on the correlated session data by determining that the anomaly is present (e.g., present in the source server, the target server, and/or anomaly detection system 102). In some non-limiting embodiments or aspects, anomaly detection system 102 may determine that the anomaly is present by comparing activity of the user account with one or more anomaly criteria. In some non-limiting embodiments or aspects, anomaly detection system 102 may determine that the anomaly is present by determining that the activity of the user account satisfies the one or more anomaly criteria. For example, anomaly detection system 102 may determine the anomaly is present by determining that the user account associated with the connection request (e.g., the user account that initiated the connection request) to the service account on the target server is not permitted to access the target server using the service account. In this way, anomaly detection system may leverage the user account identifier (e.g., username) of the user account to determine a user associated with the anomaly that initiated the connection request and/or communication session.

In some non-limiting embodiments or aspects, anomaly detection system 102 may detect an anomaly based on (e.g., using) a machine learning model. In some non-limiting embodiments or aspects, anomaly detection system 102 may detect the anomaly by transmitting the correlated session data as input to the machine learning model and using the machine learning model to provide an output (e.g., a prediction) of the machine learning model indicating that an anomaly is present based on the correlated session data.

In some non-limiting embodiments or aspects, anomaly detection system 102 may perform an action based on detecting an anomaly. For example, anomaly detection system 102 may terminate a communication session based on detecting the anomaly (e.g., detecting the anomaly based on the correlated session data associated with the communication session that is to be terminated).

In some non-limiting embodiments or aspects, anomaly criteria may refer to rules, policies, and/or definitions for an anomaly that may be specific to and/or associated with anomaly detection system 102 and/or the network of computing devices of which anomaly detection system 102 is a part. For example, anomaly criteria may include a requirement to terminate a communication session if the communication session is active for a duration that surpasses a predetermined duration. Additionally or alternatively, anomaly criteria may include a requirement to disable a service account and/or a user account (e.g., revoke access from the service account and/or user account to one or more target servers, and/or the like) based on activity of (e.g., performed by) the service account and/or user account. In some non-limiting embodiments or aspects, anomaly detection system 102 may implement one or more anomaly criteria for automatically detecting an anomaly. For example, anomaly detection system 102 may be configured to detect anomalies via software instructions, a machine learning model, and/or the like. Additionally or alternatively, anomaly detection system 102 may be configured to detect anomalies based on one or more anomaly criteria for detecting anomalies based on non-automatic (e.g., manual) detection. For example, anomaly detection system 102 may be configured to detect anomalies by providing an interface for a user to analyze correlated session data. Anomaly detection system 102 may permit the user to compare the correlated session data to the one or more anomaly criteria via the interface.

In some non-limiting embodiments or aspects, anomaly detection system 102 may generate an alert based on anomaly detection system 102 detecting the anomaly. In some non-limiting embodiments or aspects, anomaly detection system 102 may terminate the communication session for the service account based on the alert.

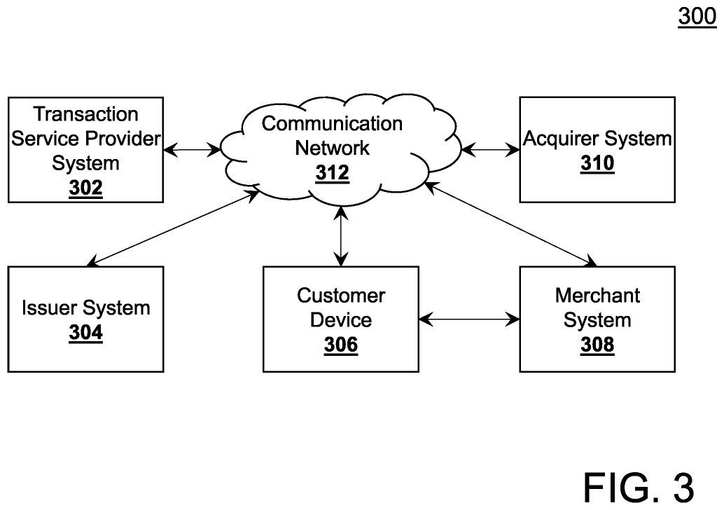

Referring now to FIG. 3, FIG. 3 is a diagram of a non-limiting embodiment or aspect of an exemplary environment 300 in which systems, products, and/or methods, as described herein, may be implemented. As shown in FIG. 3, environment 300 may include transaction service provider system 302, issuer system 304, customer device 306, merchant system 308, acquirer system 310, and communication network 312. In some non-limiting embodiments or aspects, each of anomaly detection system 102, server(s) 104, and/or data repository 106 may be implemented by (e.g., part of) transaction service provider system 302. In some non-limiting embodiments or aspects, at least one of anomaly detection system 102, server(s) 104, and/or data repository 106 may be implemented by (e.g., part of) another system, another device, another group of systems, or another group of devices, separate from or including transaction service provider system 302, such as issuer system 304, merchant system 308, acquirer system 310, and/or the like.

Transaction service provider system 302 may include one or more devices capable of receiving information from and/or communicating information to issuer system 304, customer device 306, merchant system 308, and/or acquirer system 310 via communication network 312. For example, transaction service provider system 302 may include a computing device, such as a server (e.g., a transaction processing server), a group of servers, and/or other like devices. In some non-limiting embodiments or aspects, transaction service provider system 302 may be associated with a transaction service provider, as described herein. In some non-limiting embodiments or aspects, transaction service provider system 302 may be in communication with a data storage device, which may be local or remote to transaction service provider system 302. In some non-limiting embodiments or aspects, transaction service provider system 302 may be capable of receiving information from, storing information in, communicating information to, or searching information stored in the data storage device.

Issuer system 304 may include one or more devices capable of receiving information and/or communicating information to transaction service provider system 302, customer device 306, merchant system 308, and/or acquirer system 310 via communication network 312. For example, issuer system 304 may include a computing device, such as a server, a group of servers, and/or other like devices. In some non-limiting embodiments or aspects, issuer system 304 may be associated with an issuer institution, as described herein. For example, issuer system 304 may be associated with an issuer institution that issued a credit account, debit account, credit card, debit card, and/or the like to a user associated with customer device 306.

Customer device 306 may include one or more devices capable of receiving information from and/or communicating information to transaction service provider system 302, issuer system 304, merchant system 308, and/or acquirer system 310 via communication network 312. Additionally or alternatively, each customer device 306 may include a device capable of receiving information from and/or communicating information to other customer devices 306 via communication network 312, another network (e.g., an ad hoc network, a local network, a private network, a virtual private network, and/or the like), and/or any other suitable communication technique. For example, customer device 306 may include a client device and/or the like. In some non-limiting embodiments or aspects, customer device 306 may or may not be capable of receiving information (e.g., from merchant system 308 or from another customer device 306) via a short-range wireless communication connection (e.g., an NFC communication connection, an RFID communication connection, a Bluetooth® communication connection, a Zigbee® communication connection, and/or the like), and/or communicating information (e.g., to merchant system 308) via a short-range wireless communication connection.

Merchant system 308 may include one or more devices capable of receiving information from and/or communicating information to transaction service provider system 302, issuer system 304, customer device 306, and/or acquirer system 310 via communication network 312. Merchant system 308 may also include a device capable of receiving information from customer device 306 via communication network 312, a communication connection (e.g., an NFC communication connection, an RFID communication connection, a Bluetooth® communication connection, a Zigbee® communication connection, and/or the like) with customer device 306, and/or the like, and/or communicating information to customer device 306 via communication network 312, the communication connection, and/or the like. In some non-limiting embodiments or aspects, merchant system 308 may include a computing device, such as a server, a group of servers, a client device, a group of client devices, and/or other like devices. In some non-limiting embodiments or aspects, merchant system 308 may be associated with a merchant, as described herein. In some non-limiting embodiments or aspects, merchant system 308 may include one or more client devices. For example, merchant system 308 may include a client device that allows a merchant to communicate information to transaction service provider system 302. In some non-limiting embodiments or aspects, merchant system 308 may include one or more devices, such as computers, computer systems, and/or peripheral devices capable of being used by a merchant to conduct a transaction with a user. For example, merchant system 308 may include a POS device and/or a POS system.

Acquirer system 310 may include one or more devices capable of receiving information from and/or communicating information to transaction service provider system 302, issuer system 304, customer device 306, and/or merchant system 308 via communication network 312. For example, acquirer system 310 may include a computing device, a server, a group of servers, and/or the like. In some non-limiting embodiments or aspects, acquirer system 310 may be associated with an acquirer, as described herein.

Communication network 312 may include one or more wired and/or wireless networks. For example, communication network 312 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of environment 300 may perform one or more functions described as being performed by another set of systems or another set of devices of environment 300.

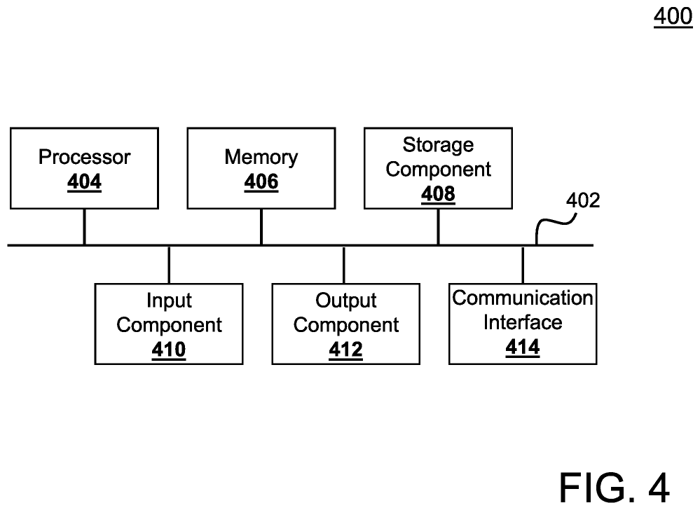

Referring now to FIG. 4, shown is a diagram of example components of a device 400, according to non-limiting embodiments or aspects. Device 400 may correspond to at least one of anomaly detection system 102, server(s) 104, and/or data repository 106 in FIG. 1 and/or at least one of transaction service provider system 302, issuer system 304, customer device 306, merchant system 308, and/or acquirer system 310 in FIG. 3, as an example. In some non-limiting embodiments or aspects, such systems or devices in FIG. 1 or FIG. 3 may include at least one device 400 and/or at least one component of device 400. The number and arrangement of components shown in FIG. 4 are provided as an example. In some non-limiting embodiments or aspects, device 400 may include additional components, fewer components, different components, or differently arranged components than those shown in FIG. 4. Additionally or alternatively, a set of components (e.g., one or more components) of device 400 may perform one or more functions described as being performed by another set of components of device 400.

As shown in FIG. 4, device 400 may include bus 402, processor 404, memory 406, storage component 408, input component 410, output component 412, and communication interface 414. Bus 402 may include a component that permits communication among the components of device 400. In some non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or configured to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404. In some non-limiting embodiments or aspects, memory 406 may be the same as or similar to data repository 106.

With continued reference to FIG. 4, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. In some non-limiting embodiments or aspects, storage component 408 may be the same as or similar to data repository 106. Input component 410 may include a component that permits device 400 to receive information, such as via user input (e.g., a touch screen display, a keyboard, a keypad, a mouse, a button, a switch, a microphone, etc.). Additionally or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

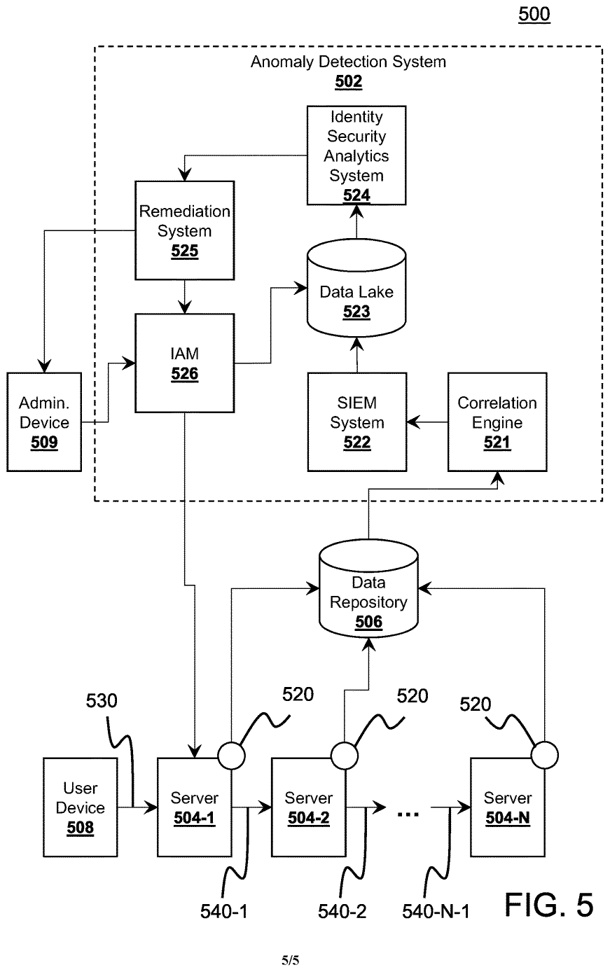

Referring now to FIG. 5, shown is a schematic diagram of an exemplary implementation 500 of a system and method for detecting anomalies in computing systems based on correlated session data, according to some non-limiting embodiments or aspects. In some non-limiting embodiments or aspects, implementation 500 may include anomaly detection system 502, a plurality of servers (e.g., first server 104-1, second server 104-2, . . . , nth server 504-N, collectively referred to as “servers 504″ and individually referred to as ”server 504″), data repository 506, user device 508, and/or administrator device 509. Anomaly detection system 502, servers 504, data repository 506, user device 508, and/or administrator device 509 may interconnect (e.g., establish a connection to communicate) via wired connections, wireless connections, or a combination of wired and wireless connections. In some non-limiting embodiments or aspects, anomaly detection system 502 may be the same as or similar to anomaly detection system 102. In some non-limiting embodiments or aspects, servers 504 may be the same as or similar to servers 104. In some non-limiting embodiments or aspects, data repository 506 may be the same as or similar to data repository 106.

User device 508 may include a computing device associated with a user. For example, the user may have a user account. In some non-limiting embodiments or aspects, the user account may enable the user to access user device 508. Additionally or alternatively, the user account may enable the user to access at least one server 504 (e.g., via user device 508). In some non-limiting embodiments or aspects, the user account may be associated with login credentials (e.g., a username of the user, a password of the user, a key associated with the user, biometric information associated with the user, other login credentials, any combination thereof, and/or the like), which the user may use (e.g., input into user device 508 and/or the like) to access user device 508 and/or at least one server 504.

In some non-limiting embodiments or aspects, user device 508 may connect to a first server 504-1 (e.g., a bastion host server and/or the like) based on the user account. For example, based on the user account, user device 508 may access first server 504-1 via production access 530.

Each server 504 may include at least one server, at least one computing device, and/or at least one processor, as described herein. For example, each server 504 may be the same as or similar to server 104. In some non-limiting embodiments or aspects, at least one server 504 (e.g., first server 504-1) may include a bastion host, as described herein.

In some non-limiting embodiments or aspects, one server 504 may receive a connection request from another server 504, as described herein. For example, second server 504-2 may receive a connection request for a connection to second server 504-2 (e.g., a target server) from first server 504-1 (e.g., a source server), as described herein. For the purpose of illustration, the connection request may include a login request to a service account on the target server (e.g., second server 504-2). In some non-limiting embodiments or aspects, the connection request may have been initiated on the source server (e.g., first server 504-1) by the user account (e.g., by the user of user device 508, which has access to first server 504-1 via production access 530). In some non-limiting embodiments or aspects, the login request may include a username of the service account and a password of the service account, as described herein. Additionally or alternatively, the login request may include a key associated with a secure shell protocol, as described herein.

In some non-limiting embodiments or aspects, a communication session for the service account may be generated between the source server (e.g., second server 504-2) and the target server (e.g., first server 504-1) based on the connection request, as described herein. Such a communication may be considered to be a lateral access (e.g., first lateral access 540-1). In some non-limiting embodiments or aspects, the communication session may be based on a secure shell protocol, as described herein.

In some non-limiting embodiments or aspects, a chain of lateral accesses may be created by repeatedly generating communications sessions between one server 504 and another server 504, as described herein. For example, after generating first lateral access 540-1 between first server 504-1 and second server 504-2, a second lateral access 540-2 may be generated between second server 504-2 and another server 504 (e.g., second server 504-2 become the source of the next lateral access, and another server will be the target server of such lateral access), and so on until the lateral access 540-N-1 is generated to the Nth server 504-N).

Each server 504 may include an agent 520 of anomaly detection system 502, as described herein. For example, agent 520 may include an instance (e.g., an instance of a software application including software instructions) of anomaly detection system 502 being executed by each server 504. In some non-limiting embodiments or aspects, each agent 520 may collect target server session data and/or source server session data, as described herein. For example, target server session data may be associated with the target server and may include a service account identifier of the service account, as described herein. The source server session data may be associated with the source server, as described herein. In some non-limiting embodiments or aspects, the source server session data (e.g., of first server 504-1) may include a user account identifier of the user account (e.g., the user account used to access the bastion host server, which may be the first link in the chain of lateral accesses, as described herein).

In some non-limiting embodiments or aspects, the target server session data may further include a source server identifier associated with the source server, a target server identifier associated with the target server, a source port number associated with the source server, a target port number associated with the target server, a target time stamp associated with a time the communication session is generated, a user account identifier of the user account, a service account identifier of the service account, any combination thereof, and/or the like.

In some non-limiting embodiments or aspects, the source server session data may further include a source server identifier associated with the source server, a target server identifier associated with the target server, a source port number associated with the source server, a target port number associated with the target server, a source time stamp associated with a time the source server receives a response from the target server that the communication session is generated, a process owner username (e.g., a user account identifier of the user account, a service account identifier of the service account, and/or the like of the account that initiated the communication session), any combination thereof, and/or the like.

The agent 520 of each server 504 may communicate the collected data (e.g., the target server session data and/or the source server session data) to and/or store the collected data in data repository 506. Data repository 506 may include a computing device (e.g., a database device and/or the like) configured to communicate with anomaly detection system 502 and/or servers 504 (e.g., agents 520 of server 504), as described herein. In some non-limiting embodiments or aspects, data repository 506 may be the same as or similar to data repository 106.

In some non-limiting embodiments or aspects, anomaly detection system 502 may include correlation engine 521, security information and event management system (SIEM) 522, data lake 523, identity security analytics system 524, remediation system 525, and/or identity access management system (IAM) 526. The components of anomaly detection system 502 are provided as an example. There may be additional components, fewer components, different components, and/or differently arranged components than those shown in anomaly detection system 502. Furthermore, two or more components shown in anomaly detection system 502 may be implemented within a single component, or a single component shown in anomaly detection system 502 may be implemented as multiple, distributed components. Additionally or alternatively, a set of components (e.g., one or more components) of anomaly detection system 502 may perform one or more functions described as being performed by another set of components of anomaly detection system 502.

In some non-limiting embodiments or aspects, correlation engine 521 may correlate the target server session data with the source server session data to provide correlated session data, as described herein. For example, correlation engine 521 may retrieve the target server session data and the source server session data from data repository 506, and correlation engine 521 may correlate the target server session data with the source server session data to provide correlated session data, as described herein. Additionally or alternatively, correlation engine 521 may communicate the correlated session data to SIEM 522, which may format and/or store the correlated session data in data lake 523.

In some non-limiting embodiments or aspects, identity security analytics system 524 may detect an anomaly based on the correlated session data, as described herein. For example, identity security analytics system 524 may retrieve correlated session data from data lake 523, and identity security analytics system 524 may detect an anomaly based on the correlated session data, as described herein.

In some non-limiting embodiments or aspects, identity security analytics system 524 identify the user account that initiated the communication session and the service account associated with the communication session based on the correlated session data, as described herein. Additionally or alternatively, identity security analytics system 524 may determine that the anomaly is present, as described herein. For example, determining that the anomaly is present may include comparing activity of the user account with one or more anomaly criteria and/or determining that the activity of the user account satisfies the one or more anomaly criteria.

In some non-limiting embodiments or aspects, identity security analytics system 524 may detect an anomaly based on (e.g., using) a machine learning model, as described herein.

In some non-limiting embodiments or aspects, identity security analytics system 524 may generate an alert based on detecting the anomaly, as described herein. For example, identity security analytics system 524 may communicate the alert to remediation system 525.

In some non-limiting embodiments or aspects, remediation system 525 may generate an alert based on detection of the anomaly, as described herein. Additionally or alternatively, remediation system 525 may communicate the alert to administrator device 509.

In some non-limiting embodiments or aspects, remediation system 525 may take remediation action based on the alert. For example, remediation system 525 may instruct IAM 526 to terminate the communication session for the user account, block the user account, disable the user account, remove the user account's access to one or more server 504 and/or service accounts of such server(s) 504, terminate the user account, any combination thereof, and/or the like.

Administrator device 509 may include a computing device associated with an administrator. For example, the administrator may use administrator device 509 to receive and/or review alerts, investigate based on the alerts, and/or determine whether to terminate a communication session and/or take other remediation action.

In some non-limiting embodiments or aspects, correlating the source and target session data, as described herein, enables identification of the original user who initiated the communication session(s) from a first server (e.g., bastion host) to impersonate a service account on one or more target servers. Additionally, the disclosed subject matter enables detection of the full chain (e.g., full journey) of lateral access from end to end. For example, once a user gains access to a target sever through lateral access, the user can further access to other target servers laterally from there, but with the techniques described herein to detect lateral access, all individual lateral access segments may be identified, and if any of these individual lateral access segments are linked together, the chain of lateral accesses from the initial server (e.g., bastion host) to the final target server through multiple steps (e.g., intermediate servers with individual lateral access segments connecting to each) may be identified. For example, each target server may be a candidate as a source server for the next lateral access, and by correlating target session data of one lateral access to the source session data of another lateral access on the same server (e.g., same host), such two lateral accesses may be detected as two links (e.g., two steps) in one chain (e.g., one long transitive access including multiple lateral accesses). By repeating such matching, the full journey of multiple lateral accesses may be detected. Furthermore, anomalies may be detected as described herein, and upon detection of an anomaly, remediation action (e.g., terminating a communication session and/or a user account) may be initiated.

The number and arrangement of systems and devices shown in FIG. 5 are provided as an example. There may be additional systems and/or devices, fewer systems and/or devices, different systems and/or devices, and/or differently arranged systems and/or devices than those shown in FIG. 5. Furthermore, two or more systems or devices shown in FIG. 5 may be implemented within a single system or device, or a single system or device shown in FIG. 5 may be implemented as multiple, distributed systems or devices. Additionally or alternatively, a set of systems (e.g., one or more systems) or a set of devices (e.g., one or more devices) of system 500 may perform one or more functions described as being performed by another set of systems or another set of devices of system 500.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with at least one processor, a connection request for a connection to a target server from a source server, the connection request comprising a login request to a service account on the target server, wherein the connection request is initiated on the source server by a user account;
generating, with at least one processor, a communication session for the service account between the source server and the target server based on the connection request;
collecting, with at least one processor, target server session data associated with the target server and comprising a service account identifier of the service account and source server session data associated with the source server and comprising a user account identifier of the user account based on the communication session;
correlating, with at least one processor, the target server session data with the source server session data to provide correlated session data; and
detecting, with at least one processor, an anomaly based on the correlated session data.

2. The computer-implemented method of claim 1, further comprising:
generating, with at least one processor, an alert based on detecting the anomaly; and
terminating, with at least one processor, the communication session for the user account based on the alert.

3. The computer-implemented method of claim 1, wherein the communication session is based on a secure shell protocol.

4. The computer-implemented method of claim 1, further comprising:
storing, with at least one processor, the target server session data and the source server session data in a data repository.

5. The computer-implemented method of claim 1, wherein the login request comprises a username of the service account and a password of the service account.

6. The computer-implemented method of claim 1, wherein the login request comprises a key associated with a secure shell protocol.

7. The computer-implemented method of claim 1, wherein the target server session data further comprises:
a source server identifier associated with the source server;
a target server identifier associated with the target server;
a source port number associated with the source server;
a target port number associated with the target server;
a target time stamp associated with a time the communication session is generated; or
any combination thereof.

8. The computer-implemented method of claim 1, wherein the source server session data further comprises:
a source server identifier associated with the source server;
a target server identifier associated with the target server;
a source port number associated with the source server;
a target port number associated with the target server;
a source time stamp associated with a time the source server receives a response from the target server that the communication session is generated; or
any combination thereof.

9. The computer-implemented method of claim 1, further comprising:
retrieving, with at least one processor, the target server session data and the source server session data from a data repository.

10. The computer-implemented method of claim 1, wherein correlating the target server session data with the source server session data to provide correlated session data comprises:
correlating a first copy of a target server identifier of the target server session data with a second copy of the target server identifier of the source session data;
correlating a first copy of a source server identifier of the target server session data with a second copy of the source server identifier of the source session data;
correlating a first copy of a target port number of the target server session data with a second copy of the target port number of the source server session data;
correlating a first copy of a source port number of the target server session data with a second copy of the source port number of the source server session data; and
correlating a target time stamp of the target server session data with a source time stamp of the source server session data, the target time stamp associated with a time the communication session is generated, the source time stamp associated with a time the source server receives a response from the target server that the communication session is generated.

11. The computer-implemented method of claim 1, wherein detecting the anomaly based on the correlated session data comprises:
identifying the user account that initiated the communication session and the service account associated with the communication session based on the correlated session data, the correlated session data comprising the user account identifier of the source server session data and the service account identifier of the target server session data; and
determining that the anomaly is present, wherein determining that the anomaly is present comprises:
comparing activity of the user account with one or more anomaly criteria; and
determining that the activity of the user account satisfies the one or more anomaly criteria.

12. A system comprising:
at least one processor; and
at least one non-transitory computer-readable medium storing instructions that, when executed by the at least one processor, cause the at least one processor to:
receive a connection request for a connection to a target server from a source server, the connection request comprising a login request to a service account on the target server, wherein the connection request is initiated on the source server by a user account;
generate a communication session for the service account between the source server and the target server based on the connection request;
collect target server session data associated with the target server and comprising a service account identifier of the service account and source server session data associated with the source server and comprising a user account identifier of the user account based on the communication session;
correlate the target server session data with the source server session data to provide correlated session data; and
detect an anomaly based on the correlated session data.

13. The system of claim 12, wherein the instructions, when executed by the at least one processor, further cause the at least one processor to:
generate an alert based on detecting the anomaly; and
terminate the communication session for the user account based on the alert.

14. The system of claim 12, wherein the communication session is based on a secure shell protocol.

15. The system of claim 12, wherein the instructions, when executed by the at least one processor, further cause the at least one processor to:
store the target server session data and the source server session data in a data repository.

16. The system of claim 12, wherein the login request comprises a username of the service account and a password of the service account.

17. The system of claim 12, wherein the login request comprises a key associated with a secure shell protocol.

18. The system of claim 12, wherein correlating the target server session data with the source server session data to provide correlated session data comprises:
correlating a first copy of a target server identifier of the target server session data with a second copy of the target server identifier of the source session data;
correlating a first copy of a source server identifier of the target server session data with a second copy of the source server identifier of the source session data;
correlating a first copy of a target port number of the target server session data with a second copy of the target port number of the source server session data;
correlating a first copy of a source port number of the target server session data with a second copy of the source port number of the source server session data; and
correlating a target time stamp of the target server session data with a source time stamp of the source server session data, the target time stamp associated with a time the communication session is generated, the source time stamp associated with a time the source server receives a response from the target server that the communication session is generated.

19. The system of claim 12, wherein detecting the anomaly based on the correlated session data comprises:
identifying the user account that initiated the communication session and the service account associated with the communication session based on the correlated session data, the correlated session data comprising the user account identifier of the source server session data and the service account identifier of the target server session data; and
determining that the anomaly is present, wherein determining that the anomaly is present comprises:
comparing activity of the user account with one or more anomaly criteria; and
determining that the activity of the user account satisfies the one or more anomaly criteria.

20. A computer program product comprising at least one non-transitory computer-readable medium including program instructions that, when executed by at least one processor, cause the at least one processor to:
receive a connection request for a connection to a target server from a source server, the connection request comprising a login request to a service account on the target server, wherein the connection request is initiated on the source server by a user account;
generate a communication session for the service account between the source server and the target server based on the connection request;
collect target server session data associated with the target server and comprising a service account identifier of the service account and source server session data associated with the source server and comprising a user account identifier of the user account based on the communication session;
correlate the target server session data with the source server session data to provide correlated session data; and
detect an anomaly based on the correlated session data.
